(19) United States
(12) Patent Application Publication
(10) Pub. No.: US 2015/0149824 A1
(43) Pub. Date: May 28, 2015

(54) METHOD AND APPARATUS FOR RECONSTRUCTING AN INDIRECTION TABLE

(71) Applicant: Violin Memory Inc., Santa Clara, CA (US)

(72) Inventor: Silei Zhang, Santa Clara, CA (US)

(73) Assignee: Violin Memory Inc., Santa Clara, CA (US)

(21) Appl. No.: 14/089,113

(22) Filed: Nov. 25, 2013

(51) Int. Cl. G06F 11/07; G06F 11/14

(52) U.S. Cl. CPC G06F 11/073; G06F 11/142
USPC 714/20

(57) ABSTRACT

A memory system contains solid state media for storing data and uses volatile memory for storing an indirection table. The indirection table maps client addresses to media addresses in the solid state media. The solid state media also stores metadata summaries maintaining the mappings of the client addresses to the media addresses within the solid state media. A media controller is configured to reconstruct the indirection table in the volatile memory from the metadata summaries stored in the solid state media based on block timestamps identifying when the metadata summaries were stored in the solid state media.

### BACKGROUND

A solid state device (SSD) may contain non-volatile memory, such as Flash memory. The SSD also may contain a controller that uses volatile memory to manage data storage in the Flash memory. For example, the SSD may store an indirection table in dynamic random access memory (DRAM). The controller tries to minimize memory usage, reduce latency, reduce storage errors, etc.

Cost constraints may limit the complexity of the controller and the amount of DRAM. The SSD cost can then be driven more by the number of Flash chips and less by the controller and DRAM. However, reduced amounts of DRAM may restrict overall SSD performance. For example, less DRAM may limit how quickly the controller can access Flash memory and thus increase overall storage latency.

### BRIEF DESCRIPTION OF THE DRAWINGS

FIG. 1 depicts an example storage system.

FIG. 2 depicts an example media controller.

FIG. 3 depicts example contexts for the storage system.

FIG. 4 depicts an example indirection table used in the storage system.

FIG. 5 depicts an example metadata summary.

FIG. 6 depicts an example process for reconstructing an indirection table.

FIG. 7 depicts an example process for generating context lists.

FIG. 8 depicts an example process for reconstructing an indirection table using context lists.

FIG. 9 depicts an example of how context lists are generated from metadata summaries.

FIG. 10 depicts an example of how context lists are used for reconstructing an indirection table.

### DETAILED DESCRIPTION

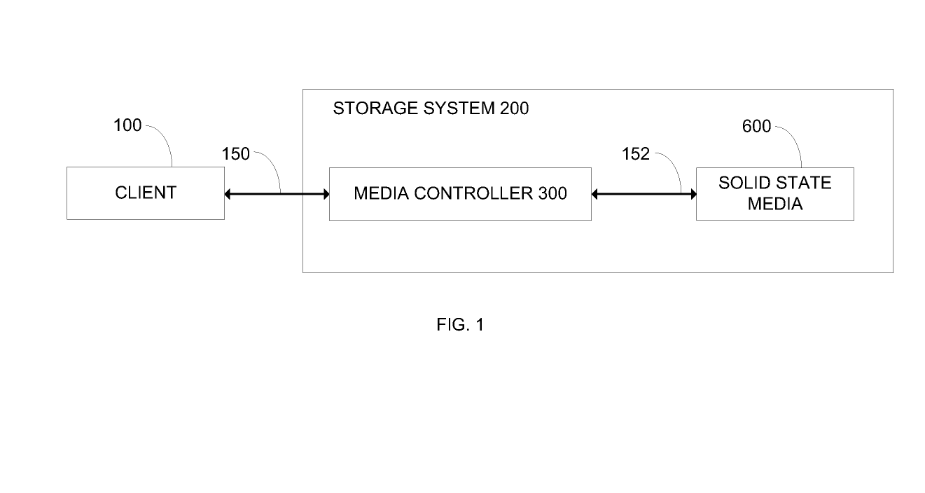

FIG. 1 shows a storage system 200 connected to a client 100. Storage system 200 may include a media controller 300 deployed between client 100 and solid state media 600.

Client 100 may be any device or application that writes and/or reads data to and from another device. For example, client 100 may comprise one or more servers, server applications, database applications, routers, switches, client computers, personal computers (PCs), Personal Digital Assistants (PDA), smart phones, digital tablets, digital notebooks, or any other wired or wireless computing device and/or software that accesses data in solid state media 600.

In another example, client 100 may comprise a stand-alone appliance, device, or blade, and the solid state media 600 may comprise a stand-alone storage array. In another example, client 100 may be a processor or software application in a personal computer or server that accesses solid state media 600 over an internal or external data bus. In a further example, client 100 may be a gateway or proxy device providing access to storage system 200 to one or more stand-alone appliances, devices or electronic entities. Said access may be provided by cabled connection, wireless connections or other means of communication with client 100.

Solid state media (SSM) 600 may comprise any device that stores data accessed by another device, application, software, client, or the like, or any combination thereof. For example, SSM 600 may comprise one or more solid state device (SSD) chips or dies that contain one or more flash memories. In another example, SSM 600 may comprise storage disks, rotating disk devices, integrated memory devices, or the like, or any combination thereof. SSM 600 may exist locally within the same physical enclosure as media controller 300 and/or client 100 or may exist externally in a chassis connected to client 100 and/or media controller 300.

Media controller 300 receives read and write commands from client 100. The write and read commands may include associated storage addresses. Media controller 300 writes or reads data associated with the addresses to and from SSM 600. Media controller 300 maps the addresses from client 100 to physical address locations within SSM 600. Media controller 300 may include an indirection table that stores the address mappings between the client addresses received from client 100 and the physical addresses in SSM 600.

Client 100, media controller 300, and/or solid state media 600 may be directly connected together, or connected to each other through a network or fabric. In one example, client 100, media controller 300, and/or solid state media 600 are coupled to each other via wired or wireless connections 120.

Different communication protocols can be used over connection 150 between client 100 and media controller 300, and connection 152 between media controller 300 and SSM 600. Example protocols may include Fibre Channel Protocol (FCP), Small Computer System Interface (SCSI), Advanced Technology Attachment (ATA) and encapsulated protocols such as Fibre Channel over Ethernet (FCoE), Internet Small Computer System Interface (ISCSI), Fibre Channel over Internet Protocol (FCIP), ATA over Ethernet (AoE), Internet protocols, Ethernet protocols, or the like, or any combination thereof. Protocols used between client 100 and storage system 200 also may include tunneled or encapsulated protocols to allow communication over multiple physical interfaces such as wired and wireless interfaces. Connections 150 and 152 may use the same protocols or different protocols.

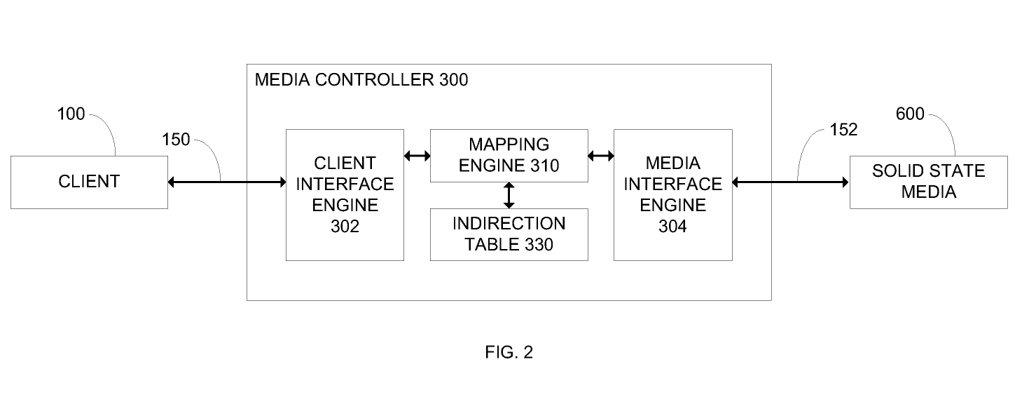

FIG. 2 depicts an example media controller 300. Client interface engine 302 receives read and write operations from client 100 over connection 150. Mapping engine 310 maps client addresses for the read and write operations to media addresses within SSM 600. Client addresses are alternatively referred to as virtual addresses and media addresses within SSM 600 are alternatively referred to as physical addresses.

Mapping engine 310 finds an address in indirection table 330 corresponding to the client address. The identified address in the indirection table contains a media address. Mapping engine 310 sends the media address to media interface engine 304. Media interface engine 304 then accesses the data in SSM 600 associated with the identified media address.

In one example, media controller 300 may store indirection table 330 in a volatile DRAM that needs power to maintain stored information. When media controller 300 is powered off and then powered back on, mapping engine 310 may need to reconstruct indirection table 330 with the mappings between the client addresses used by client 100 and the media addresses used by SSM 600. As described in more detail below, media controller 300 may use a large amount of time and a large amount of DRAM to reconstruct indirection table 330.

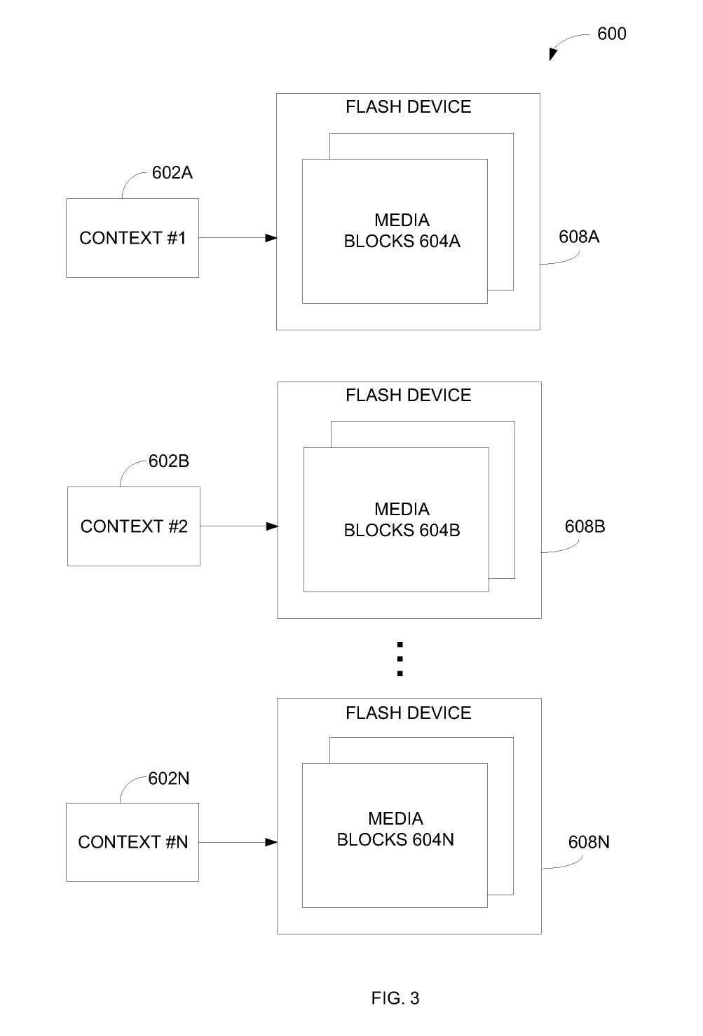

FIG. 3 depicts an example hierarchical flash memory structure within SSM 600. SSM 600 may consist of one or more Flash devices 608 each including multiple planes. Each plane may include a separate interface for connecting to media controller 300. Each plane also may include multiple blocks of memory 604 (media blocks). In one example, each media block 604 constitutes the smallest erasable portion of memory within Flash device 608. Example sizes of media blocks 604 may comprise 4, 8, or 16 megabytes (MBs).

Each media block 604 may comprise 256 pages each being 8 thousand bytes (8 KBs) or 16 KBs. The media controller might erase 4, 8, and/or 16 MB blocks 604 but may only be able to write to 8 or 16 KB pages. Read operations may span a page, groups of consecutive pages or portions of a page. Of course these are just examples and media blocks 604, pages, reads, and writes may be any size.

Contexts 602 may be any combination of software and hardware that separately assess Flash devices or dies 608 within SSM 600. Contexts 602 may access different flash devices or dies 608 to increase the speed of write and read operations in SSM 600. For example, a first context 602A may access a first set of media blocks 604A for a first set of Flash devices or dies 608A. A second context 602B may separately access a second set of media blocks 604B for a second set of Flash devices or dies 608B within SSM 600, etc.

Each context 602 may access some number of Flash devices 608. For example, each context 602 may manage the media blocks 604 and pages within eight different Flash devices 608 and use any of the eight Flash devices 608 for storing data. Of course, this is just one example and any number and type of memory devices and memory sizes may be accessed by any number of contexts 602.

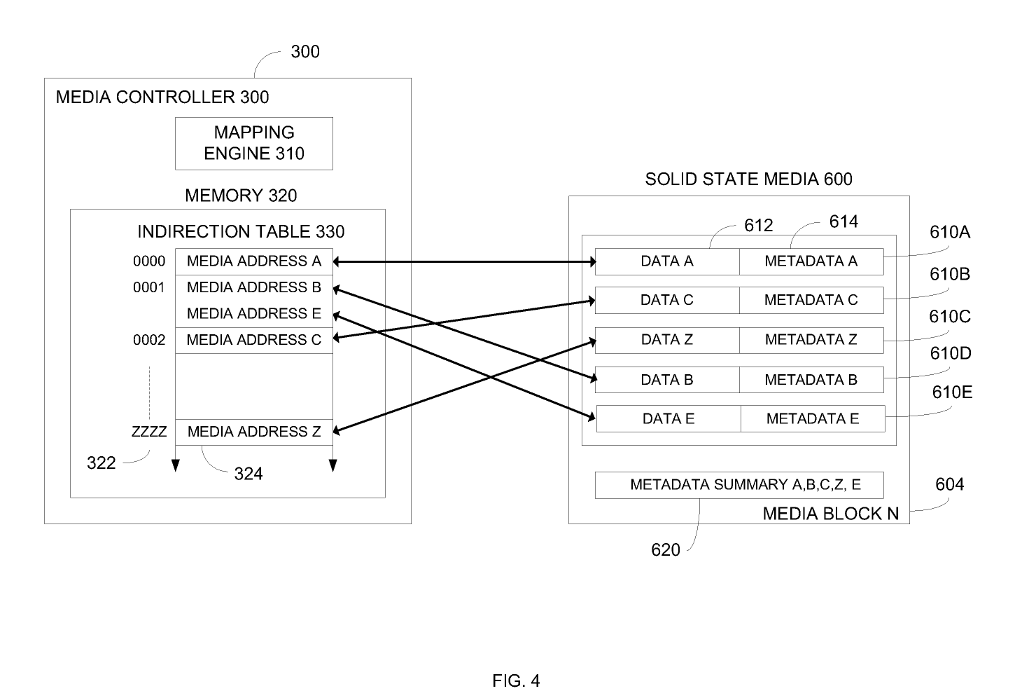

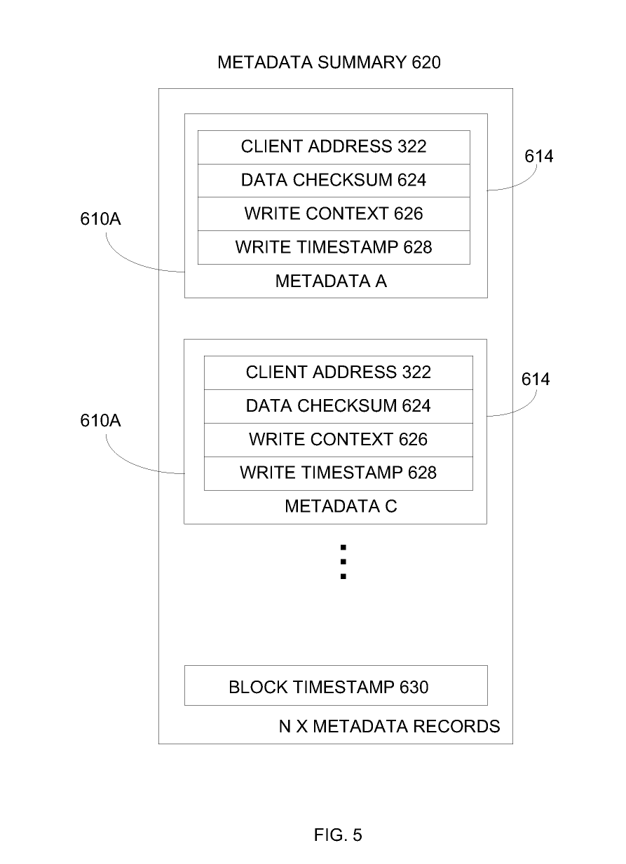

Referring to FIGS. 4 and 5, client addresses 322 represent addresses received from client 100 in FIG. 1 and may have corresponding addresses within memory 320. For example, each client address 322 may correspond to a particular address offset in memory 320. Media addresses 324 represent physical addresses within SSM 600 that contain data associated with client addresses 322. In one example, each media address 324 may correspond to a 1 KB sub-block of data within a particular media block 604. These sub-blocks of data are alternatively referred to as lines 610.

Each 1 KB line 610 of SSM 600 may contain media or data 612 and metadata 614. In one example, metadata A in line 610A may include a client address 322, a data checksum 624, a write context 626, and a write timestamp 628.

As mentioned above, memory 320 may comprise volatile DRAM that loses information during a power off or reset condition. Client addresses 322 in metadata 614 may be stored in non-volatile Flash devices within SSM 600 and are retained during the power off or reset condition. After media controller 300 is powered back on, mapping engine 310 uses metadata 614 in SSM 600 to reconstruct indirection table 330 in volatile memory 320.

For example, metadata A in line 610A may contain client address 0000. After a power up, mapping engine 310 may store media address A for line 610A into address location 0000 of indirection table 330. As mentioned above, addresses in indirection table 330 may not necessarily map one-to-one with client addresses 322. For example, addresses in indirection table 330 may be offset from client addresses 322.

Flash devices within SSM 600 may be prone to errors. Media controller 300 may use data checksums 624 to correct errors in associated data 612. For example, data checksums 624 may comprise a 24, 32, or 40 bit error-correcting codes (EEC), such as a BCH code. In this example, checksums 624 represent fields of data which may be populated by arbitrary error-correcting codes rather than exclusively the physical checksum operation as known to those skilled in the art of logic design.

As also explained above, different contexts may write in parallel to different blocks or pages in SSM 600. For example, client 100 may write different data to the same address multiple times. The writes may be written by the different contexts to different Flash devices. Metadata 614 contains context identifiers 626 that identify which contexts wrote the data into SSM 600.

Media controller 300 may receive a read operation from the client having address 0001. Mapping engine 310 accesses indirection table 330 and identifies associated media address B. Mapping engine 310 reads data B and metadata B from line 610D and, if necessary, uses data checksum 624 in metadata B to correct data B. Mapping engine 310 also may confirm client address 322 in metadata B points back to address 0001.

Media controller 300 may receive a write operation that writes data E into address 0001. Media controller 300 needs to overwrite data B in line 610D with new data E. However, media controller 300 might only be able to erase data on a per block bases and may only be able to write data on a per page bases.

Data A, data C, data Z, and data B are stored in lines 610A-610D, respectively. Each line 610A-610D may only be 1 KB. Media controller 300 may need to wait for 8 or 16 lines of data before writing to an 8 KB or 16 KB page in SSM 600. Thus, media controller 300 cannot overwrite data B with data E in the 1 KB line 610D.

Instead, media controller 300 may write new data E into a new line 610E in another page of the same or a different block 604. Media controller 300 then may update address 0001 in indirection table 330 to point to media address E for line 610E. Now metadata B for line 610D and metadata E for line 610E both include client address 0001.

Media controller 300 uses write timestamps 628 to distinguish between metadata 614 that points back to the same address locations in indirection table 300. Media controller 300 may use metadata 614 with the most recent write timestamp 628 to reconstruct indirection table 330. For example, when reconstructing indirection table 330, media controller 300 determines both metadata B and metadata E contain client address 0001. Media controller 300 stores media address E in client address 0001 of indirection table 330 since metadata E has a more recent write timestamp 628.

To maximize performance, indirection table may have a linear association with SSM 600. A linear indirection table 330 may need to be relatively large to store media addresses for all of lines 610 in a large SSM 600. For example, assume SSM 600 is one terabyte (TB) and lines 610 are 1 KB. Indirection table 330 would need 1 billion entries each holding a 32 bit media address 324. Therefore, indirection memory 320 would need 4 GBs to store one billion entries each containing the 32 bit address (4 bytes). It would also take a relatively long time for media controller 3000 to read metadata 614 from every line 610 of SSM 600 and reconstruct indirection table 330.

To reduce reconstruction time, media controller 300 writes a metadata summary 620 at the end of each media block 604. Metadata summary 620 includes copies of all metadata 614 for all lines 610 of block 604. For example, media data summary 620 in FIG. 5 contains client address 322, data checksum 624, write context 626, and write timestamp 628 for each line 610 in block 604. Media controller 300 then only needs to read one page containing metadata summary 620 to obtain all of metadata 614 for media bock 604.

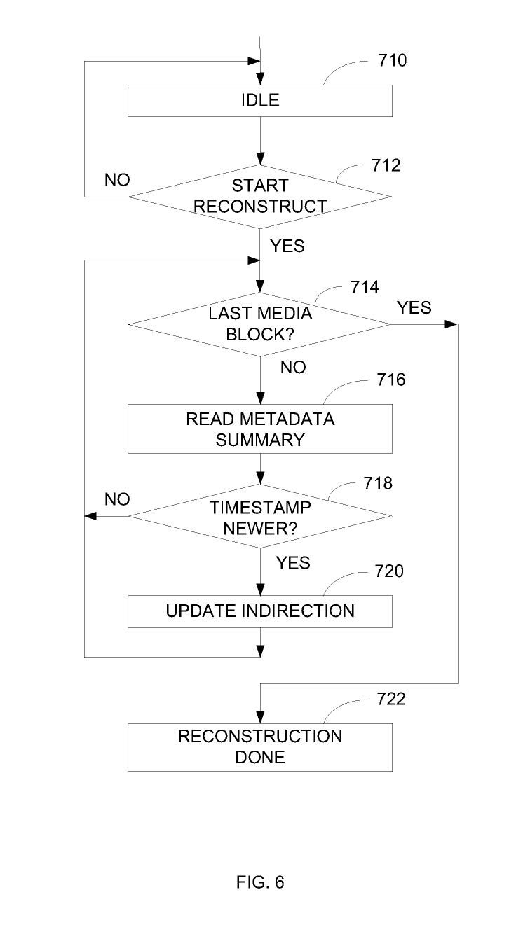

FIG. 6 explains how the media controller may rebuild the indirection table from metadata summaries. The media controller may detect an idle state in operation 710, such as a power off or reset state. Operation 712 starts reconstructing the indirection table in response to a start event, such as a power-on or reset of the memory system.

Operation 716 reads the metadata summary for a first media block in the SSM. As explained above, the metadata summary includes a copy of all of the metadata for all of the lines in the media block. For each entry in the metadata summary, the media controller stores the associated media address in the identified client address of the indirection table.

For example, the first entry in the metadata summary for the first media block in the SSM may be associated with media address 0000. The first entry may include the client address 0007. If no entry currently exists in indirection table address 0007, the timestamp for the metadata summary entry is by default the most recent timestamp in operation 718. The media controller stores media address 0000 in indirection table address 0007.

The media controller then reads the next entry in metadata summary for the next line of the block. The next entry may include an indirection table address that already includes a media address. The media controller compares the timestamp in the redirection table with the timestamp in the metadata summary.

The media controller may update the media address in the indirection table with the media address in the metadata summary when the metadata summary timestamp is more recent than the indirection table timestamp. For example, referring back to FIG. 4, media controller 300 may initially write media address B into address location 0001 of indirection table 330. Media controller 300 later may read metadata E from metadata summary 620. Metadata E also contains client address 0001 and also contains a more recent write timestamp than metadata B. Media controller 300 in operation 720 of FIG. 6 replaces media address B in indirection table address 0001 with media address E.

Reconstruction of the indirection table is completed in operation 722 when the media controller completes processing the metadata summary for the last media block of the SSM. After reconstruction is completed, the indirection table contains the media addresses for the most recent client write operations.

Referring again to FIGS. 4 and 5, write timestamps 628 in FIG. 5 may be large, such as 64 bits (8 bytes). There may be a limited amount of memory 320. In the example given above, SSM 600 comprised one terabyte (TB) of data and lines 610 are 1 KB. Indirection memory 320 would then need 4 GBs of memory to store one billion different line addresses that are each 32 bits wide (4 bytes). Indirection memory 320 would need to be three times larger to also store the 8 byte timestamps. For example, 1 billion entries x (4 bytes+8 bytes)=12 GBs.

Due to cost constraints, it may be desirable to keep indirection memory 320 as small as possible. One technique for reducing the size of memory 320 would be to restore ⅛ or 1/16 of indirection table 330 at a time. For example, media controller 300 may read the metadata for a first eighth of SSM 600 and sort the media addresses as described above in FIG. 6. Media controller 300 then reads the metadata for a second eighth of SSM 600. The media controller then compares the metadata with the indirection table entries reconstructed from the first eighth of SSM 600.

However, media controller 300 now needs to read through the entire SSM memory 8 or 16 times and compare every line timestamp value with the previously loaded indirection entries. The repeated reads to SSM 600 and timestamp comparisons may substantially increase the amount of time needed for reconstructing indirection table 330.

### Block Sorting

A block sorting technique reconstructs indirection table 330 within existing memory constraints without requiring a large number of repeated accesses to SSM 600. As described above, blocks are associated with contexts and the pages and lines within a particular block are written by the same context.

The media controller may sort metadata summaries on a block level, instead of sorting metadata for individual pages or individual lines within each block. For example, the media controller may sort 4, 8 and 16 MB media blocks instead of sorting individual line entries within each of the media blocks. This higher level block sorting uses substantially less memory 320 when reconstructing indirection table 320.

The media controller or logic circuitry within SSM 600 uses a particular context for handling a particular write operation. Multiple contexts may write to different data blocks within SSM 600. The media controller identifies in the metadata 614 the write context 626 for each line of data written into SSM 600.

Each context writes lines, within pages, within media blocks, one media block at a time. Entries in each metadata summary 620 are written into each media block at monotonically increasing times. Thus, data for a first address is written into a media block prior to data subsequently written into higher addresses of the same block. Metadata summaries 620 are written into the media blocks after all of the lines have been written into the media block.

The media controller then sorts media blocks 604 for a particular context based on a block timestamp 630 (FIG. 5) associated with metadata summary 620. The media controller does not have to track timestamps for individual lines 610 within media blocks 604 thus reducing by orders of magnitude the amount of memory 320 needed for reconstructing indirection table 330.

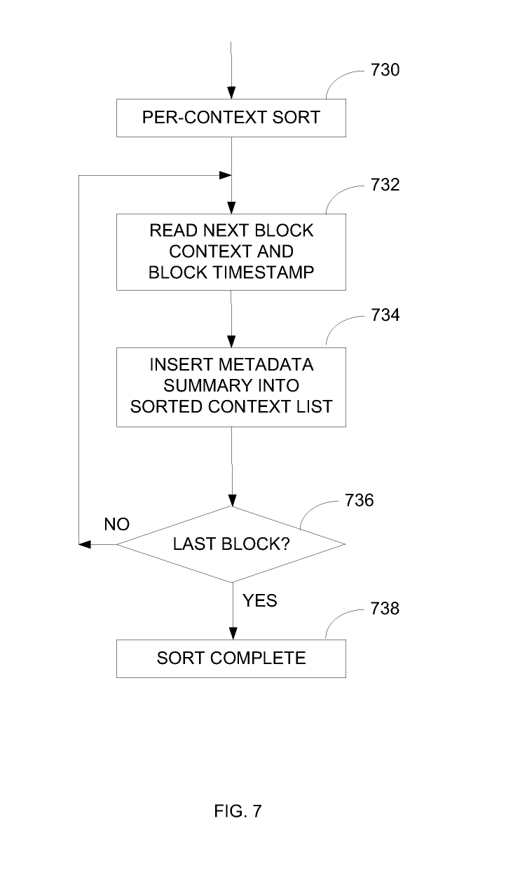

Referring to FIGS. 5 and 7, an example process is described for sorting the metadata summaries for different contexts. The media controller in operation 730 starts a per-context based sorting operation in response to a power-on or reset condition. The media controller in operation 732 reads the metadata summary for a first block within SSM 600 and identifies the block context identifier and block timestamp. For example, the media controller may identify one of write contexts 626 in metadata summary 620. The media controller may have previously added block timestamp 630 into the metadata summary identifying a time when metadata summary 620 was written into SSM 600.

In operation 734, the media controller inserts the metadata summary into a sorted context list based on the block timestamp 630. For example, a first metadata summary for a first block may be associated with context A. The first metadata summary may include a first block timestamp. The first metadata summary may be stored in a first position of a context list A or may be identified as having the first position within the context list A.

Operation 732 reads a second metadata summary for a second block in SSM 600. The context identifier may indicate the second metadata summary is also associated with context A. The second metadata summary may include a second block timestamp older than the first block timestamp. The media controller may store the second metadata summary in the first position of context list A and move the first metadata summary to a second position within context list A. A similar operation is performed for other contexts within the SSM. Context based block sorting is completed in operation 738 after the context summary for the last block in the SSM is sorted in operation 734.

The metadata summaries stored in memory 320 may need to include block timestamp 630, write context 626, and client addresses 322 for the individual lines within the block. Memory 320 no longer needs to store write timestamps 628 for each individual line within the block. Therefore, memory 320 no longer needs to store the additional 8 bytes of write timestamps 628 for one billion line entries (8 GBs).

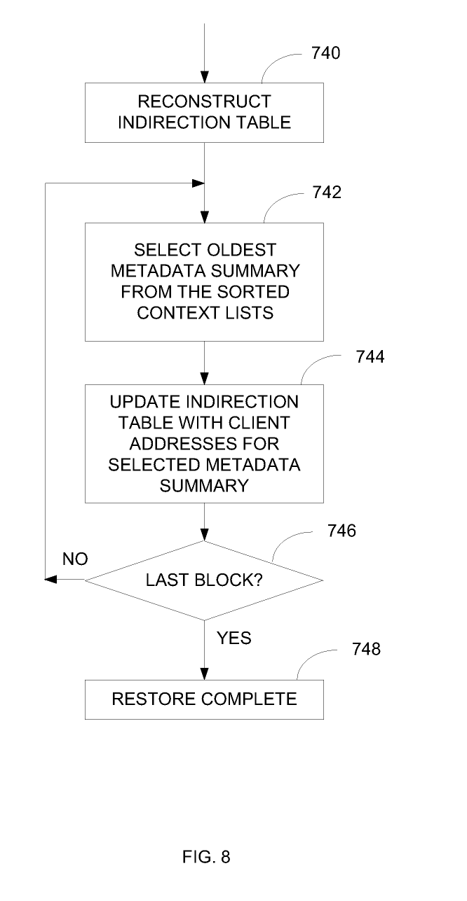

FIG. 8 depicts an example process for reconstructing the indirection table from the sorted context lists. In operation 740, the media controller starts the second stage of indirection table reconstruction. Memory 320 currently contains sorted context lists each containing metadata summaries associated with a particular context. The metadata summaries contain the client addresses for the lines in the associated block and a block timestamp identifying when the metadata summary was written into the block. The block timestamps identify a chronological order the metadata summaries were previously written into the SSM. The metadata summaries may be sorted in order from oldest to most recent.

Operation 742 selects the oldest metadata summary from all of the different sorted context lists. For example, a first entry in each of the sorted context lists may contain the oldest metadata summary for the associated context. The media controller selects the first entry with the oldest block timestamp. All of the lines associated with the selected block were written before the metadata summary. Thus, the metadata summary contains the client addresses for the oldest written lines in the SSM.

Operation 744 updates the indirection table with the client addresses contained in the selected oldest metadata summary. For example, a first entry in the oldest metadata summary may be associated with media address 0000 and identify client address 0005. The media controller stores media address 0000 into address 0005 of the indirection table.

The same indirection table restoration is performed for all of the remaining entries in the oldest metadata summary. For example, a second entry in the oldest metadata summary may be associated with media address 0001 and identify client address 0111. Media address 0001 is stored in address 0111 of the indirection table. The media controller removes the oldest metadata summary from the associated context list after all of the media addresses for the block are loaded into the indirection table.

Operation 742 identifies the next oldest metadata summary from the remaining context lists. As explained above, lines for a particular block are written into SSM 600 prior to the media controller writing the associated metadata summary into SSM 600. Therefore, the metadata summary with the next oldest block timestamp implicitly contains client addresses for lines with the next oldest set of timestamps.

All of the entries in the next oldest metadata summary are also more recent than any entries previously loaded into the indirection table from the previous oldest metadata summaries. All of the lines in the next oldest metadata summary were also written into SSM 600 in sequential order. Accordingly, operation 744 loads the entries in the next oldest metadata summary in sequential order into the indirection table. Entries previously loaded into the indirection table with matching client addresses are replaced with the entries in the next oldest metadata summary.

The next oldest metadata summary is then removed from the associated context list and operation 746 repeats the reconstruction process for a next oldest metadata summary from the context lists. Restoration is completed in operation 748 when the entries in the last/most recent metadata summary are loaded into the indirection table.

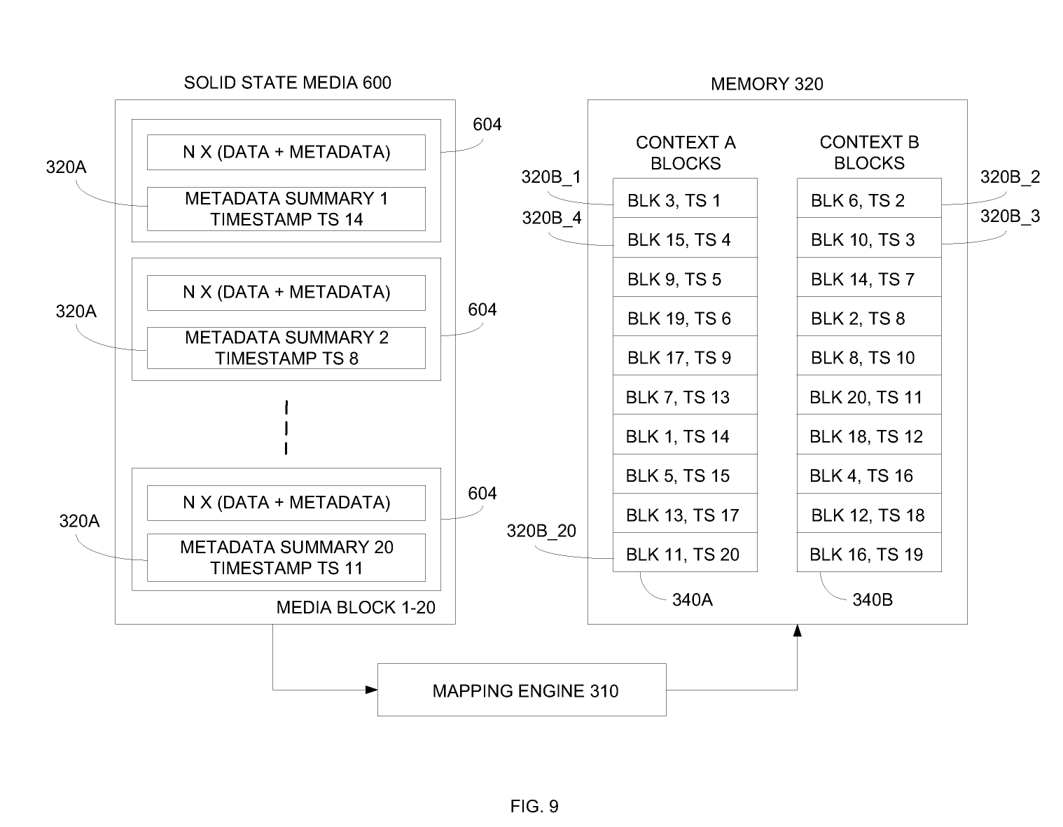

FIG. 9 depicts another example of how metadata summaries 320A in SSM 600 are sorted in memory 320. Metadata summaries 320A in SSM 600 are each similar to metadata summary 320 shown in FIG. 5 and may include client addresses 322, data checksums 624, write context identifiers 626, write timestamps 628 for each line within an associated media block 604, and block timestamp 630.

After the memory system is powered on, mapping engine 310 reconstructs the indirection table in memory 320. Mapping engine 310 only needs to write portions of metadata summaries 320A into memory 320 as metadata summaries 320B. Metadata summaries 320B may not need to include the data checksums 624 or includes write timestamps 628 for individual lines. Thus, metadata summaries 320B use substantially less storage space than metadata summaries 320A.

Mapping engine 310 may determine from write contexts 626 (FIG. 5) in metadata summaries 320A that media blocks 1, 3, 5, 7, 9, 11, 13, 15, 17, and 19 were all previously written into SSM 600 by context A. Mapping engine 310 also may determine that media blocks 2, 4, 6, 8, 10, 12, 14, 16, 18, and 20 were all previously written into SSM 600 by context B. Accordingly, mapping engine 310 may write metadata summaries 320B associated with context A into a first context list 340A and may write metadata summaries 320B associated with context B into a second context list 340B.

Mapping engine 310 sorts metadata summaries 320B chronologically based on the associated block timestamps TS 1-TS 20. For example, timestamp TS 1 may be the oldest timestamp corresponding to the oldest media block 3 written into the SSM. Timestamp TS 20 may be the most recent timestamp corresponding to the most recently written block 11 written into the SSM.

Mapping engine 310 sorts the metadata summaries 320B for context list 340A and context list 340B. In this example, the oldest metadata summary 320B_1 in context list 340A is for block 3 having timestamp TS 1, followed by metadata summary 320B_4 for block 15 with timestamp TS 4, etc. The oldest metadata summary 320B_2 for context list 340B is for block 6 with timestamp TS 2, followed by metadata summary 320B_3 for block 10, with timestamp TS 3, etc.

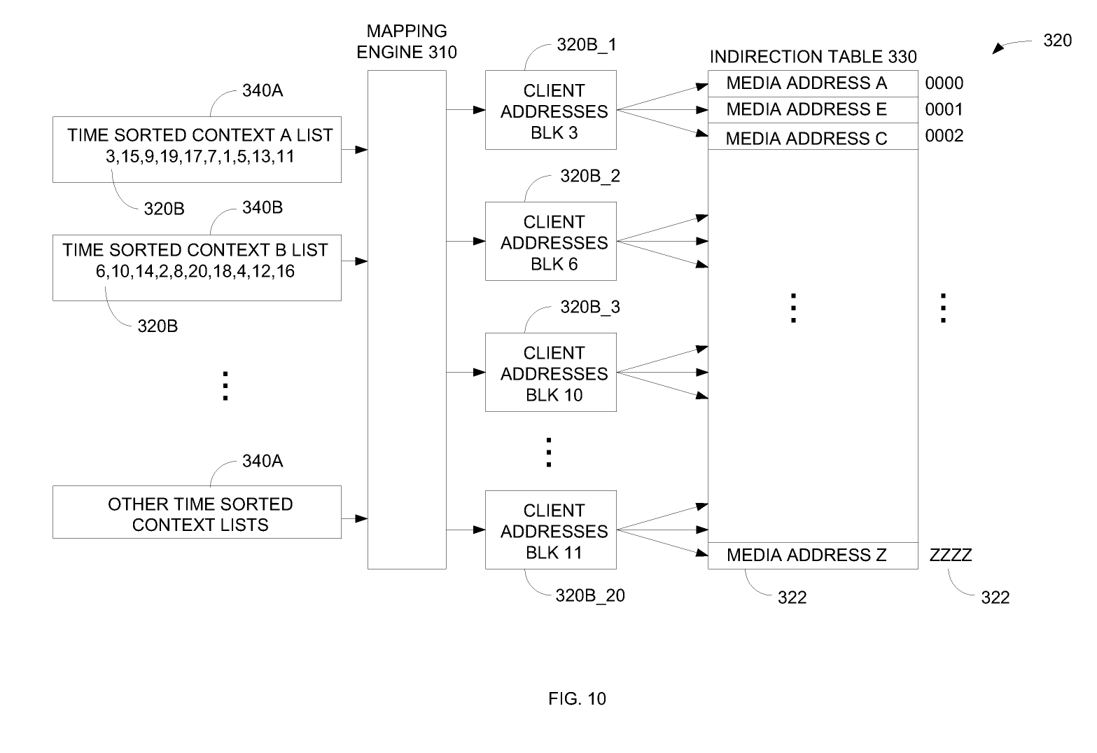

FIG. 10 depicts an example showing how indirection table 330 is rebuilt from sorted context lists 340. Mapping engine 310 compares the oldest metadata summaries 320B in each of context lists 340. As mentioned before, context lists 340 may be presorted from oldest metadata summary to most recent metadata summary. Mapping engine 310 only needs to compare the block timestamp for block 3 in context list 340A with the block timestamp for block 6 in context list 340B. In this example, block timestamp TS 1 for block 3 is older than block timestamp TS 2 for block 6.

Mapping engine 310 writes media addresses 322 for the lines of block 3 into the indirection table 330. For example, a first entry in metadata summary 320B_1 may be for media address A and have the client address 0000. Media address A is loaded into indirection table address 0000. Metadata summary 320B_1 is removed from context list 340A after all of the entries are loaded into indirection table 330.

The next oldest remaining metadata summary 320B for block 15 in context list 340A is compared with the oldest metadata summary 320B for block 6 in context list 340B. In this example, block timestamp TS 2 in metadata summary 320B_2 for block 6 is older than block timestamp TS 4 in metadata summary 320B_3 for block 15. Accordingly, mapping engine 310 writes the media addresses 322 for block 6 into indirection table 330. Metadata summary 320B_2 is then removed from context list 340B.

Mapping engine 310 then compares the block timestamps for the next two oldest blocks 15 and 10 in context lists 340A and 340B, respectively. The process is repeated until media addresses 322 associated with the most recent metadata summary 320B_20 are written into indirection table 330.

Thus, mapping engine 310 uses substantially less volatile memory 320 to reconstruct indirection table 330. Mapping engine 310 leverages characteristics of solid state memory where writes are performed in blocks using multiple contexts. Mapping engine 310 also leverages characteristics of the SSM where lines and pages within a particular block are written in sequential chronological order.

Mapping engine 310 only needs to identify the block timestamps indicating when metadata summaries are written into the SSM. Write timestamps for individual lines within a particular block are then assumed to be older than the block timestamp. This prevents mapping engine 310 from having to load and/or sort individual line timestamps when reconstructing indirection table 330. Additionally, mapping engine 310 requires only a single pass through SSM.

### Hardware and Software

Several examples have been described above with reference to the accompanying drawings. Various other examples are also possible and practical. The systems and methodologies may be implemented or applied in many different forms and should not be construed as being limited to the examples set forth above. Some systems described above may use dedicated processor systems, micro controllers, programmable logic devices, or microprocessors that perform some or all of the operations. Some of the operations described above may be implemented in software or firmware and other operations may be implemented in hardware.

For the sake of convenience, the operations are described as various interconnected functional blocks or distinct software modules. This is not necessary, however, and there may be cases where these functional blocks or modules are equivalently aggregated into a single logic device, program or operation with unclear boundaries. In any event, the functional blocks and software modules or features of the flexible interface can be implemented by themselves, or in combination with other operations in either hardware or software.

### Digital Processors, Software and Memory Nomenclature

As explained above, embodiments of this disclosure may be implemented in a digital computing system, for example a CPU or similar processor. More specifically, the term “digital computing system,” can mean any system that includes at least one digital processor and associated memory, wherein the digital processor can execute instructions or “code” stored in that memory. (The memory may store data as well.)

A digital processor includes but is not limited to a microprocessor, multi-core processor, Digital Signal Processor (DSP), Graphics Processing Unit (GPU), processor array, network processor, etc. A digital processor (or many of them) may be embedded into an integrated circuit. In other arrangements, one or more processors may be deployed on a circuit board (motherboard, daughter board, rack blade, etc.). Embodiments of the present disclosure may be variously implemented in a variety of systems such as those just mentioned and others that may be developed in the future. In a presently preferred embodiment, the disclosed methods may be implemented in software stored in memory, further defined below.

Digital memory, further explained below, may be integrated together with a processor, for example Random Access Memory (RAM) or FLASH memory embedded in an integrated circuit Central Processing Unit (CPU), network processor or the like. In other examples, the memory comprises a physically separate device, such as an external disk drive, storage array, or portable FLASH device. In such cases, the memory becomes “associated” with the digital processor when the two are operatively coupled together, or in communication with each other, for example by an I/O port, network connection, etc. such that the processor can read a file stored on the memory. Associated memory may be “read only” by design (ROM) or by virtue of permission settings, or not. Other examples include but are not limited to WORM, EPROM, EEPROM, FLASH, etc. Those technologies often are implemented in solid state semiconductor devices. Other memories may comprise moving parts, such a conventional rotating disk drive. All such memories are “machine readable” in that they are readable by a compatible digital processor. Many interfaces and protocols for data transfers (data here includes software) between processors and memory are well known, standardized and documented elsewhere, so they are not enumerated here.

### Storage of Computer Programs

As noted, some embodiments may be implemented or embodied in computer software (also known as a “computer program” or “code”; we use these terms interchangeably). Programs, or code, are most useful when stored in a digital memory that can be read by one or more digital processors. The term “computer-readable storage medium” (or alternatively, “machine-readable storage medium”) includes all of the foregoing types of memory, as well as new technologies that may arise in the future, as long as they are capable of storing digital information in the nature of a computer program or other data, at least temporarily, in such a manner that the stored information can be “read” by an appropriate digital processor. The term “computer-readable” is not intended to limit the phrase to the historical usage of “computer” to imply a complete mainframe, mini-computer, desktop or even laptop computer. Rather, the term refers to a storage medium readable by a digital processor or any digital computing system as broadly defined above. Such media may be any available media that is locally and/or remotely accessible by a computer or processor, and it includes both volatile and non-volatile media, removable and non-removable media, embedded or discrete.

Having described and illustrated a particular example system, it should be apparent that other systems may be modified in arrangement and detail without departing from the principles described above. Claim is made to all modifications and variations coming within the spirit and scope of the following claims.

1. An apparatus, comprising:
logic circuitry configured to:
identify metadata summaries for associated blocks within a solid state memory;
identify block timestamps associated with the metadata summaries;
identify contexts associated with the metadata summaries;
generate context lists of the metadata summaries associated with the same contexts;
sort the metadata summaries in the context lists based on the associated timestamps; and
reconstruct an indirection table from the context lists, wherein the indirection table maps client addresses to media addresses within the solid state memory.

2. The apparatus of claim 1, wherein the wherein the reconstruction is accomplished by parsing the sorted context lists irrespective of timestamps associated with individual write entries within the blocks.

3. The apparatus of claim 1, wherein:
the indirection table is stored in volatile memory;
the solid state memory comprises non-volatile memory; and
the logic circuitry is configured to reconstruct the indirection table in the volatile memory from the metadata summaries stored in the non-volatile memory.

4. The apparatus of claim 1, wherein the metadata summaries are a last section of data written into the blocks and the block timestamps indicate when the metadata summaries were written into the blocks.

5. The apparatus of claim 1, wherein the metadata summaries contains context identifiers identifying which of the contexts wrote data into the blocks and the contexts comprise software and/or hardware that separately write the data into different devices or dies within the solid state memory.

6. The apparatus of claim 1, wherein the indirection table maps the client addresses to media addresses for different lines within the blocks of the solid state memory.

7. The apparatus of claim 1, wherein the logic circuitry is further configured to:
sort the metadata summaries in each of the context lists in order from the metadata summaries with an oldest one of the block timestamps to the metadata summaries with a most recent one of the block timestamps;
identify a set of the metadata summaries comprising one of the metadata summaries from each of the context lists with the oldest one of the block timestamps;
identify an oldest one of the set of the metadata summaries; and
reconstruct the indirection table based on the client addresses identified in the oldest one of the set of the metadata summaries.

8. The apparatus of claim 7, further comprising:
remove the oldest one of the set of metadata summaries from the context lists;
identify a next set of the metadata summaries comprising one of the metadata summaries from each of the context lists with the oldest one of the block timestamps;
identify a oldest one of the metadata summaries from the next set of the metadata summaries; and
reconstruct the indirection table from the client addresses identified in the oldest one of the metadata summaries from the next set of metadata summaries.

9. The apparatus of claim 1, wherein the logic circuitry is further configured to:
receive a write operation from a client comprising data and a new client address;
write the data into a new media address in the solid state memory;
generate a write timestamp indicating when the data was written into the solid state memory;
update the indirection table to map the new client address to the new media address;
write a new metadata summary into the solid state memory that includes a new block timestamp indicating when the new metadata summary was written into the solid state memory and associates the new client address and the write timestamp with the new media address; and
reconstruct the indirection table from the new metadata summary using the new block timestamp without using the write timestamp.

10. A method, comprising:
generating metadata summaries containing context identifiers and block timestamps, wherein the block timestamps indicate when the metadata summaries are written into blocks in the memory;
generating context lists identifying the metadata summaries associated with the same context identifiers;
sorting the metadata summaries in the context lists based on the block timestamps; and
reconstructing an address mapping table from the metadata summaries based on how the metadata summaries are sorted in the context lists.

11. The method of claim 10, further comprising reconstructing the address mapping table without using or comparing timestamps for individual write entries within the blocks.

12. The method of claim 10, further comprising:
identifying a set of the metadata summaries comprising one of the metadata summaries from each of the context lists with an oldest one of the block timestamps; and
identifying an oldest one of the set of metadata summaries for a first reconstruction phase of the address mapping table.

13. The method of claim 12, further comprising:
removing the oldest one of the set of metadata summaries from one of the context lists;
identifying a next set of the metadata summaries comprising one of the metadata summaries from each of the context lists with an oldest one of the block timestamps; and
identifying a oldest one of the next set of metadata summaries for a second reconstruction phase of the address mapping table.

14. The method of claim 10, further comprising:
identifying an oldest one of the metadata summaries in the context lists;
identifying a first client address in the oldest one of the metadata summaries;
identifying a first media address associated with a first client address; and
loading the first media address into a location of the address mapping table associated with the first client address;
identifying a second client address in the oldest one of the metadata summaries;
identifying a second media address associated with a second client address; and
loading the second media address into a location of the address mapping table associated with the second client address.

15. The method of claim 14, further comprising:
after loading all media addresses from the oldest one of the metadata summaries into the address mapping table;
identifying a next oldest one of the metadata summaries in the context lists;
identifying a first client address in the next oldest one of the metadata summaries;
identifying a first media address associated with the first client address in the next oldest one of the metadata summaries;
loading the first media address into a location of the address mapping table associated with the first client address in the next oldest one of the metadata summaries;
identifying a second client address in the next oldest one of the metadata summaries;
identifying a second media address associated with the second client address in the next oldest one of the metadata summaries; and
loading the second media address into a location of the address mapping table associated with the second client address in the next oldest one of the metadata summaries.

16. The method of claim 10, further comprising:
identifying client addresses in the metadata summaries;
identifying media addresses in the memory associated with the client addresses; and
loading the media addresses into locations of the address mapping table associated with the client addresses based on the block timestamps and based on an order of the client addresses in the metadata summaries.

17. The method of claim 10, further comprising:
receiving a write operation from a client comprising data and a client address;
writing the data into a media address in the memory;
generating a write timestamp indicating when the data is written into the memory;
updating the address mapping table to map the client address to the media address;
writing a new metadata summary into the memory that includes a new block timestamp indicating when the new metadata summary was written into the memory and associates the client address and the write timestamp with the media address; and
reconstructing the address mapping table from the new metadata summary using the new block timestamp without using the write timestamp.

18. An apparatus, comprising:
volatile memory configured to store an indirection table;
solid state media configured to store metadata summaries identifying addresses in the indirection table associated with blocks of media addresses within the solid state media; and
a media controller configured to reconstruct the indirection table in the volatile memory from the metadata summaries stored in the solid state media based on block timestamps indicating when the metadata summaries were stored in the solid state media.

19. The apparatus of claim 18, wherein the indirection table is reconstructed without using or comparing timestamps for individual write entries within the blocks.

20. The apparatus of claim 18, wherein the media controller is further configured to:
generate context lists identifying the metadata summaries associated with a same context;
identify an order of the metadata summaries in the context lists based on the block timestamps; and
reconstruct the indirection table based on the order of the metadata summaries in the context lists.

21. The apparatus of claim 20, wherein the media controller is further configured to:
identify a first set of metadata summaries comprising one of the metadata summaries in each of the context lists with an oldest one of the block timestamps;
identify an oldest one of the first set of metadata summaries;
use the oldest one of the first set of metadata summaries for a first reconstruction of the indirection table;
remove the oldest one of the first set of metadata summaries from the context lists;
identify a second set of metadata summaries comprising one of the metadata summaries remaining in each of the context lists with an oldest one of the block timestamps;
identify an oldest one of the second set of metadata summaries; and
use the oldest one of the second set of metadata summaries for a second reconstruction of the indirection table.
